(19) United States
(12) Patent Application Publication
(10) Pub. No.: US 2012/0094056 A1
(43) Pub. Date: Apr. 19, 2012

(54) COMPOSITE MATERIAL AND METHOD FOR PRODUCING A COMPOSITE MATERIAL

(75) Inventor: Joerg Vollmann-Schipper, Biberach (DE)

(73) Assignee: ALBERT HANDTMANN ELTEKA GMBH & CO. KG, Biberach (DE)

(21) Appl. No.: 13/378,109

(22) PCT Filed: Jun. 14, 2010
(86) PCT No.: PCT/EP10/58298

§ 371 Date: Jan. 4, 2012

(30) Foreign Application Priority Data
Jun. 16, 2009 (DE) 10 2009 026 977.0

(51) Int. Cl. B32B 1/04; B32B 3/26

(52) U.S. Cl. 428/76; 428/304.4

(57) ABSTRACT

The invention relates to a composite material (10), comprising a metal component (20), in particular a metal foam component, preferably an aluminum foam component, and Lauramid (30) with which the metal component (20) is encapsulated, as well as to a method for producing the composite material (10) in a working step during the casting process.

### TECHNICAL FIELD

The present invention relates to a composite material as well as to a method for producing such composite material.

### BRIEF DISCUSSION OF RELATED ART

The number of fields in which composite materials can be used increases continuously. Moreover, there are again and again developed new composite materials in order to use them for certain purposes. For example, there are known composite materials where glass fiber or carbon fiber mats, plastics or wood veneer are adhesively bonded to a metal component, in particular an aluminum foam component. Such adhesive bonding is often done by means of an epoxy resin. On the one hand, a disadvantage of this is that the adhesive bonding requires an additional time and cost intensive process step in order to produce such a composite material. On the other hand, it is an aim to improve the properties of composite materials, in particular their wear resistance, corrosion resistance, chemical resistance, e.g. to salt water, as well as their dry-running properties.

### BRIEF SUMMARY

Therefore, the present invention provides a composite material having improved properties, which composite material can also be produced by means of a simple and cost-efficient method.

That is, the invention provides a composite material and a method for producing such composite material

A composite material according to the invention comprises a metal component, such as in particular a metal foam component and preferably an aluminum foam component—such as they are for example available from suppliers as purchased parts or outsourced items as per geometric specifications—which composite material is at least partially surrounded or enclosed by, in particular completely encapsulated with, Lauramid®. As a result, there is created a highly wear-resistant and salt-water resistant composite or hybrid material having good corrosion and dry-running properties and high chemical resistance, which composite at the same time also exhibits high rigidity at low weight. Thus, the composite material according to the invention is highly suitable for use in automotive engineering and aircraft construction. The composite material according to the invention is also suitable for rail vehicles as well as for the purpose of reducing resonance effects and absorbing or diminishing shocks in many areas of mechanical engineering, as well as for shielding electromagnetic fields, the so-called EMC shielding. A special field of application of the composite material according to the invention, for example, is the use as a material for the load-bed of transporters and trailers. Lauramid® is a polyamid material of class PA 12G, which is distributed by Albert Handtmann Elteka GmbH & Co. KG.

Preferably, the metal component is designed open-pored at least at its edges, which may be achieved for example by corresponding saw cuts for separating individual metal components from a larger cast metal foam part. Consequently, the Lauramid may easily penetrate into the pores of the metal component and connect inseparably with the metal component by forming cross-linking or interlocking. This minimizes the risk that the Lauramid separates from the metal component, no adhesive being required.

It is possible to obtain a particularly wear-resistant component made from the composite material according to the invention when the metal component is completely or at least essentially completely enclosed by the Lauramid. “Essentially completely enclosed” here means that the metal component is surrounded by Lauramid except for those surfaces of the metal component which had possibly been in contact with or rested against retaining elements for supporting the metal component in a casting mold when the metal component was encapsulated with Lauramid during the casting process.

According to an advantageous further development of the invention, the metal component is designed as a flat element of relatively small thickness, which metal component comprises two main surfaces completely or at least essentially covered by Lauramid. Thus, the respective main surfaces are well-protected from wear, i.e. they exhibit favorable properties with respect to abrasion. Since the small side surfaces are not covered by Lauramid, several such elements may easily be arranged adjacent to one another and be assembled together, e.g. by means of tongue and groove joints as facade elements or the like.

The thickness of the metal component depends on the requirements on the entire component. In practice, however, it has been shown that the Lauramid preferably should have a wall width or thickness of at least 5 mm. From such dimensions onwards—for example by means of X-ray inspection—it can be observed that there is no damage or only insignificant damage at the boundary surface between the Lauramid and the metal component. Such damage could be due e.g. to large- area detachment (i.e. cavities or shrinkage) between the Lauramid and the metal component. Such X-ray inspections also serve to detect dirt.

The invention further provides a method for producing a composite material, which preferably is a composite material according to the above explanation. The method according to the invention comprises the following steps:

There is provided a metal component, such as in particular a metal foam component and preferably an aluminum foam component, which is encapsulated with Lauramid. The term “encapsulate” or “pour” means that the Lauramid in liquid form is brought into contact with the metal component in order to connect with the latter.

A particularly favorable method results from the fact that prior to encapsulation the metal component is arranged in a casting mold and fixed therein by means of retaining elements. Corresponding retaining plates, retaining mandrels or retaining keys may be considered as retaining elements.

The number of defects in the composite material according to the invention may be minimized if it is taken care that, when the Lauramid is poured into the casting mold, the temperature of the casting mold and that of the metal component is held in the range of 140° C. to 160° C., wherein a range of about 150° C. to 154° C. may be preferred. A particularly preferred value for the temperature of the casting mold may be about 152° C.

The quality of the composite material according to the invention may be further improved if prior to encapsulation the metal component is pre-heated to a temperature in the range of about 120° C. to 160° C., in particular about 130° C. to 150° C., wherein a value of about 140° C. may be most preferred when pre-heating the metal component. Moreover, the temperature of the molten Lauramid during encapsulation preferably amounts to about 150° C. to 170° C. and more preferably about 158° C. to 162° C., wherein a value of about 160° C. is most preferred.

The molten Lauramid is stirred prior to being poured into the mold. Stirring times of 5 to 15 minutes, in particular of about 7 to 10 minutes, and particularly preferably of about 8 to 8.5 minutes are advantageous since the Lauramid assumes then a viscosity which makes it possible to form a particularly strong connection with the aluminum foam. Stirring times of about 8 to 8.5 minutes and temperatures of about 160° C. make it even possible to completely fill the foam structure when the Lauramid is poured, so that a connection between the plastic material and the metal component results, which is practically no longer separable.

In practice, in order to achieve a high quality of the composite material according to the invention, it has proven to be advantageous to wash the metal component prior to pouring or encapsulation or to subject it to an ultrasound treatment in order to clean it. Alternatively, it may be advantageous to refrain from washing or ultrasound treatment prior to pouring or encapsulation.

The essence of the invention is the production of a light-weight composite material whose composite can no longer be mechanically separated. Preferably, the composite is composed only of Lauramid and the metal component, in particular an aluminum foam part, without any additional connecting elements such as adhesives or resins. The composite is produced in one production step and is finished after the casting process. There is no need for any additional processes or machinery. Therefore, no additional investment is required.

### BRIEF DESCRIPTION OF THE DRAWINGS

Further advantages, features and particularities of the present invention result from the following detailed description of advantageous embodiments of the composite material according to the invention and of the corresponding method for producing the same. The Figures show:

FIG. 1 is a side cross-sectional view of a casting mold with a composite material according to a first embodiment of the invention, which composite material is held in the casting mold by retaining elements,

FIG. 2 is a side cross-sectional view of a casting mold with a second embodiment of the composite material according to the invention, which composite material is held in the casting mold by retaining elements,

FIG. 3 is a top plan cross-sectional view of a casting mold with a third embodiment of the composite material according to the invention, which composite material is held in the casting mold by retaining elements, and

FIG. 4 is a greatly magnified detailed view of a composite material according to the invention.

### DETAILED DESCRIPTION

During the production of the various embodiments of the composite material 10 according to the invention, the metal component—such as an aluminum foam plate or an aluminum foam body—was centered in the casting mold and pre-heated as well as secured in the casting mold against floating

X-ray inspection showed in each case that the composite material 10 according to the invention has a satisfactorily small number of pores.

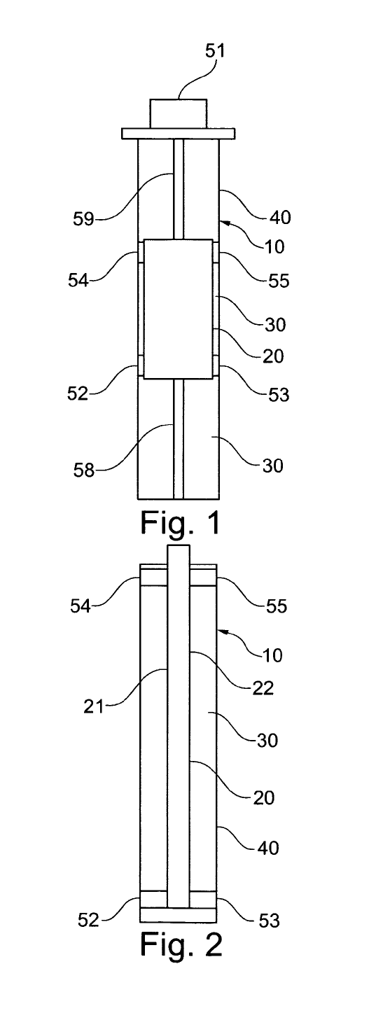

According to what is shown in FIG. 1, a first embodiment of the composite material 10 according to the invention is produced in that an aluminum foam body 20, which represents a non-limiting example of a metal component, is arranged in a casting mold 40. By means of retaining elements 52 to 55, which may be designed as retaining plates or mandrels, the aluminum foam body 20 is fixed in the casting mold 40 so that it cannot move horizontally. Moreover, the aluminum foam body 20 is secured in the casting mold 40 against movement in the vertical direction by retaining elements 58 and 58, which may also be designed as retaining plates or mandrels. In order to efficiently prohibit the aluminum foam body 20 from floating in the casting mold 40 when the Lauramid 30 is poured, a retaining element 51 in the form of a heavy holding block exerts a force from above on the aluminum foam body 20. As can be seen from FIG. 1, the aluminum foam body 20 is completely enclosed by Lauramid 30. To put it more exactly, the aluminum foam body 20 is only essentially completely surrounded by Lauramid 30 since there is no Lauramid 30 on the aluminum foam body 20 at those sites where during the pouring process holding elements 52 to 55 and 58, 59 rest against the aluminum foam body 20.

In order to produce the first embodiment of the composite material 10 according to the invention, the temperature of the casting mold was set to 150° C., the aluminum foam body 20 exhibited a temperature of 131° C. and the temperature of the Lauramid melt amounted to 163° C. The aluminum foam body 20 with a size of 200×20×70 mm was arranged in a casting mold dimensioned 200×30×200 mm after the aluminum foam body 20 had been ultrasonically cleaned and dried in a laboratory oven for seven hours at 140° C. Then, Lauramid was poured. The wall thickness of the Lauramid at the larger surfaces thereof, which are shown at the left-hand and right-hand sides here, amounted to 5 mm. The Vicat softening temperature of the composite material 10 amounted to 172.1° C., while that of a separately poured sample bar amounted to 173° C. In a comparison of the Vicat sample with the Vicat test plate a series plate (sample) was compared to the Vicat value of the composite plate. Both castings were produced from the same material charge under the same casting conditions. The values obtained were verified in several tests (casts).

Due to the relatively thin wall of 5 mm some damage became already visible from the outside prior to X-raying. It was observed that the composite material 10 in the area of the aluminum foam body 20 had not shrunk, i.e. that it had a thickness of 30 mm corresponding to the size of the casting mold, while it had shrunk to a thickness of 29.2 mm at the remaining sites of pure Lauramid 30.

The difference in weight between a composite material 10 according to the invention from aluminum foam encapsulated with Lauramid and pure Lauramid amounts to 30%. Thus, with identical volumes, the mass of the pure Lauramid amounted to 320 g compared to 213 g of a composite material 10.

According to FIG. 2, in a second embodiment of the composite material 10 according to the invention, the metal component is designed as a flat aluminum foam plate 20. The aluminum foam plate 20 comprises a first main surface 21 which is shown at the left of FIG. 2 and a second main surface 22 which is shown at the right, both surfaces being almost completely covered by Lauramid 30. As can be taken from FIG. 2, the end face of the aluminum foam plate 20 protruding at the top of the casting mold 40 is not covered by Lauramid, and also those sites where the retaining elements 52 to 55 rest against the aluminum foam plate 20 while the Lauramid is poured into the casting mold 40 are free from Lauramid. A retaining plate for securing the aluminum foam plate 20 against floating during the pouring process is not shown in FIG. 2 for the sake of simplicity, and anyway, does not form part of the composite material 10 according to the invention.

For producing the second embodiment of the composite material 10 according to the invention, two aluminum foam plates 20, each dimensioned 200×5×20 mm were arranged in a casting mold of 200×30×200 mm, after having been ultrasonically cleaned and dried for seven hours at 160° C. in the laboratory oven. Then, Lauramid was poured. During the production, the temperature of the casting mold was set to 156° C., the aluminum foam bodies 20 exhibited a temperature of 123° C., and the temperature of the Lauramid melt amounted to 161° C. The Vicat softening temperature both of the composite material 10 and of a separately encapsulated sample bar amounted to 177° C. On their main surfaces 21, 22, the aluminum foam plates 20 were covered by Lauramid, which initially had a wall thickness of about 12.5 mm. From this casting the two aluminum foam plates 20 were then sawed and milled such that in one of the two variants the Lauramid had a wall thickness of 3 mm, while it had a wall thickness of 5 mm in the other variant. In the composite material 10 with a wall thickness of the Lauramid of 3 mm, several instances of damage were observed along the foam surface, which damage was cut open by the milling process. Individual instances of damage thus were found in a range of 3 mm from the metal foam part or metal component. In the case of a remaining wall thickness of 5 mm no defects were observed on the worked surface.

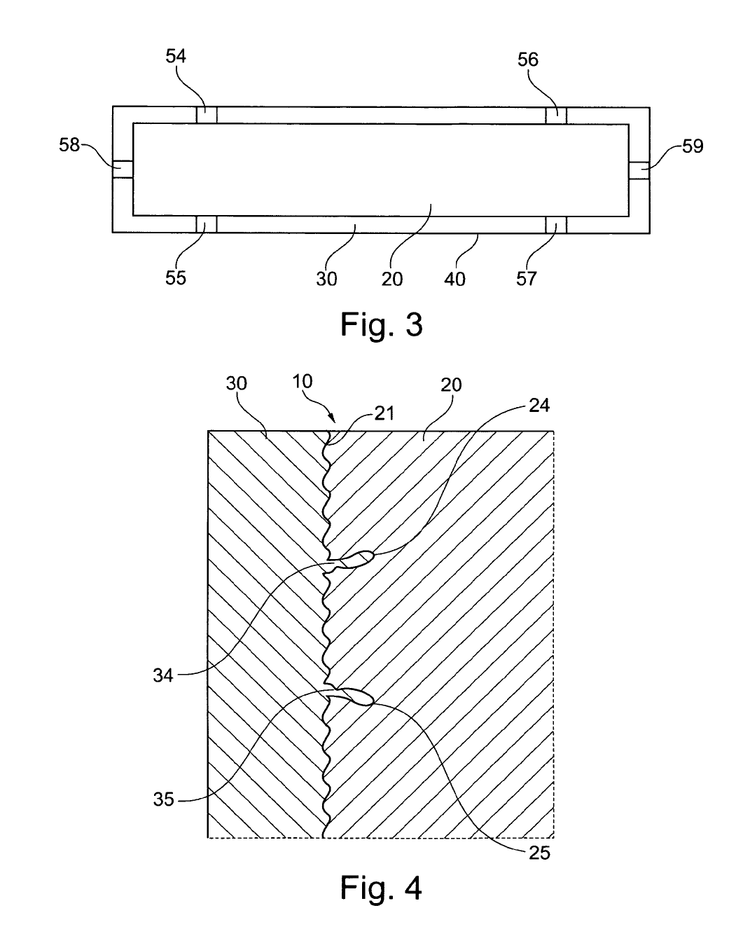

FIG. 3 shows a sectional view from above through a casting mold 40 in which an aluminum foam plate 20 dimensioned 295×45×9 mm is arranged. Holding elements 54 to 59 center the aluminum foam plate 20 in the casting mold 40. Moreover, the aluminum foam plate 20 is secured against floating in the casting mold 40, which however is not shown in the Figure. A third embodiment of a composite material 10 according to the invention was produced by pouring Lauramid, wherein the Lauramid has a wall thickness of about 5 mm. From said third embodiment two variants were produced on a pilot basis in a casting mold dimensioned 200×30×200 mm: In the first variant, an aluminum foam with 30 ppi (pores per inch) was used, while in the second variant, an aluminum foam with 40 ppi was used. Both variants were produced with outer dimensions of 307×53×20 mm. In the first variant, the mass amounted to 342 g, while in the second variant, the mass amounted to 346 g. In comparison, a body having the same outer dimensions without using aluminum foam was cast from Lauramid only; said body had a mass of 325 g.

X-ray inspection showed that in the two variants using an aluminum foam plate the entire foam structure of said aluminum plate was filled with Lauramid. When producing said embodiment, the temperature of the casting mold 40 was held at 152° C., the temperature of the aluminum foam plate amounted to 130° C., and the temperature of the Lauramid melt amounted to 160° C. The Vicat softening temperature of the thus produced composite materials was measured to be 170.3° C. Said temperature is at the bottommost end of the allowable material specifications for Lauramid. The Vicat softening temperature of a separately cast sample bar was measured to be 174° C.

The respective aluminum foam plates for producing the two latter composite material variants were not washed, neither were they subjected to ultrasound treatment.

FIG. 4 is an enlarged view of an example of a composite material 10 according to the invention. To put it more exactly, the boundary surface between the aluminum foam plate 20 and the Lauramid 30 is shown on a magnified scale. Here, it is clearly visible that, for example, the first main surface 21 shown as a smooth surface in FIG. 2 indeed exhibits much roughness, which is due to the fact that the aluminum foam plate 20 is a foamed structure. It has not only to be taken into account that the first main surface 21 exhibits a high degree of roughness, but that pores 24 and 25, which also here are shown by way of example only, protrude into the interior of the aluminum foam body 20. Into said pores 24 and 25 corresponding fastening noses or fastening projections 34, 35 protrude which are formed by the Lauramid 30 penetrating into said pores 24, 25. As a result, it is possible to create a particularly inseparable and unreleasable connection, in particular by interlocking or cross-linking, between the Lauramid and the aluminum foam body.

It should be noted that the features of the invention described with reference to individual embodiments, both regarding the composite material and the method for producing the same—such as the exact design and the dimensions of the metal component and the outer shell made from Lauramid, individual process parameters such as temperatures or material properties—may be present also in other embodiments, unless it is otherwise indicated or technically unfeasible.

1-11. (canceled)

12. A composite material,
comprising a metal foam component and Lauramid which at least partially surrounds the metal foam component.

13. The composite material according to claim 12,
wherein the metal foam component is open-pored at least at its edges.

14. The composite material according to claim 12,
wherein the metal foam component is encapsulated with Lauramid.

15. The composite material according to claim 12,
wherein the metal foam component is designed as a flat component comprising two main surfaces, and wherein essentially only the two main surfaces are covered by Lauramid.

16. The composite material according to claim 12,
wherein the Lauramid has a wall thickness of at least 5 mm.

17. A method for producing a composite material, comprising the steps: providing a metal foam component and encapsulating the metal foam component with Lauramid.

18. The method according to claim 17,
wherein prior to encapsulation the metal foam component is arranged in a casting mold and secured in the casting mold by means of retaining elements.

19. The method according to claim 18,
further comprising, pouring the Lauramid into the mold, wherein a temperature of the casting mold, and a temperature of the metal foam component, amounts to about 140° C. to 160° C.

20. The method according to claim 17,
wherein prior to encapsulation the metal foam component is pre-heated to a temperature in the range of about 120° C. to 160° C.

21. The method according to claim 17,
wherein during encapsulation a temperature of molten Lauramid amounts to about 150° C. to 170° C.

22. The method according to claim 17,
wherein prior to encapsulation the metal foam component is washed or subjected to an ultrasound treatment.

23. The composite material according to claim 12, wherein the metal foam component comprises an aluminum foam component.

24. The composite material according to claim 14, wherein the metal foam component is essentially completely enclosed by Lauramid

25. The method according to claim 17, wherein said providing the metal foam component comprises providing an aluminum foam component.
